(19) United States
(12) Patent Application Publication
(10) Pub. No.: US 2024/0391456 A1
(43) Pub. Date: Nov. 28, 2024

(54) VEHICULAR SENSING SYSTEM WITH POTENTIAL IMPACT DETERMINATION

(71) Applicant: Magna Electronics Inc., Auburn Hills, MI (US)

(72) Inventor: Reinhard Juette, Mainhausen (DE)

(21) Appl. No.: 18/669,815

(22) Filed: May 21, 2024

Related U.S. Application Data
(60) Provisional application No. 63/503,526, filed on May 22, 2023.

(51) Int. Cl. B60W 30/09; B60Q 9/00; B60R 1/07; B60R 1/12; B60W 10/18; B60W 10/20; G01S 13/931

(52) U.S. Cl. CPC B60W 30/09; B60Q 9/00; B60R 1/07; B60R 1/12; B60W 10/18; B60W 10/20; G01S 13/931; B60R 2001/1223; B60W 2554/801; G01S 2013/93274

(57) ABSTRACT

A vehicular sensing system includes a sensor disposed at a vehicle and capturing sensor data. The vehicular sensing system, responsive to detecting an object present exterior of the vehicle, and based on a predicted path of travel of the equipped vehicle approaching the detected object, estimates a distance between the detected object and a lateral outermost part of the equipped vehicle at a side of the equipped vehicle that, as the equipped vehicle moves along the predicted path of travel and approaches the detected object, will be closest to the detected object. The vehicular sensing system determines that the distance between the lateral outermost part of the equipped vehicle and the detected object is less than a threshold distance.

### CROSS REFERENCE TO RELATED APPLICATION

The present application claims the filing benefits of U.S. provisional application Ser. No. 63/503,526, filed May 22, 2023, which is hereby incorporated herein by reference in its entirety.

### FIELD OF THE INVENTION

The present invention relates generally to a vehicle sensing system for a vehicle, and, more particularly, to a vehicle sensing system that utilizes one or more sensors at a vehicle.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular sensing system for a vehicle includes a sensor disposed at a vehicle equipped with the vehicular sensing system and sensing exterior of the vehicle. The sensor captures sensor data. The system includes an electronic control unit (ECU) including electronic circuitry and associated software. The sensor is operable to capture sensor data and the sensor data is transferred to the ECU. The electronic circuitry of the ECU includes a data processor for processing sensor data captured by the sensor and transferred to the ECU. The vehicular sensing system, via processing at the ECU of the sensor data captured by the sensor, detects an object present exterior of the vehicle. The equipped vehicle has a lateral outermost part at a side of the equipped vehicle. Responsive to detecting the object present exterior of the vehicle, the vehicular sensing system, based on a predicted path of travel of the equipped vehicle approaching the detected object, estimates a distance between the detected object and the lateral outermost part of the equipped vehicle at the side of the equipped vehicle that, as the equipped vehicle moves along the predicted path of travel and approaches the detected object, will be closest to the detected object. The vehicular sensing system determines that the distance between the lateral outermost part of the equipped vehicle and the detected object being less than a threshold distance.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates sensors;

FIG. 2 is a schematic view of a vehicle with sensors mounted at the exterior rearview mirrors of the vehicle;

FIG. 3 is a schematic view of the vehicle, shown with the vehicle operating alongside other vehicles; and

FIG. 4 is a schematic view of a vehicle towing a trailer and including laterally extended exterior rearview mirrors, shown with the vehicle towing the trailer alongside other vehicles.

### DESCRIPTION OF THE PREFERRED EMBODIMENTS

A vehicular sensing system and/or alert system operates to capture data representative of the exterior of the vehicle and may process the captured data to detect objects at or near the vehicle and in the area of the vehicle, such as to assist a driver of the vehicle in maneuvering the vehicle in a forward or rearward direction. The sensing system includes a processor or processing system that is operable to receive sensor data from one or more sensors (e.g., image sensors, radar sensors, lidar sensors, ultrasonic sensors, etc.).

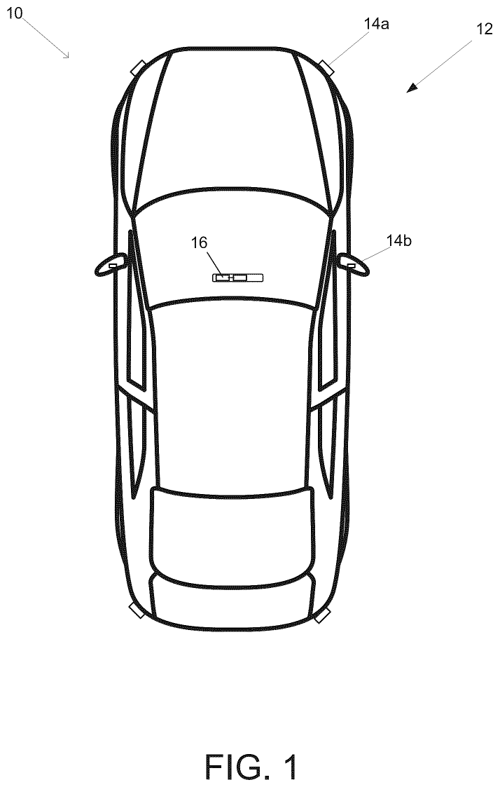

Referring now to the drawings and the illustrative embodiments depicted therein, a vehicle 10 (FIG. 1) includes a driving assistance system or vehicular sensing system 12 that includes at least one exterior viewing sensor, such as a radar sensor, a lidar sensor, and/or an ultrasonic sensor, which, for example, may be disposed at one or both exterior rearview mirrors 14b at one or both sides of the vehicle and/or may be disposed at one or more corners 14a of the vehicle (e.g., at a corner of a bumper). The sensor(s) capture sensor data representative of the scene occurring exterior the vehicle 10 (e.g., at least forward and/or sideward of the vehicle). The sensing system 12 includes a control or electronic control unit (ECU) 16 having electronic circuitry and associated software, with the electronic circuitry including a data processor or image processor that is operable to process sensor data captured by the sensors or other sensors (e.g., lidar, ultrasonic, cameras, etc.), whereby the system or ECU may detect or determine presence of objects or the like and alert an occupant of the vehicle. The ECU 16 or sensing system 12 may be part of a driving assist system of the vehicle 10, where the driver assist system controls at least one function or feature of the vehicle (such as to provide autonomous driving control of the vehicle) responsive to processing of the sensor data captured by the sensors. The data transfer or signal communication from the camera to the ECU may comprise any suitable data or communication link, such as a vehicle network bus or the like of the equipped vehicle.

When operating a vehicle in narrow conditions such that limited space on either side of the vehicle exists, such as a parking lot or a narrow road, side-mounted exterior rearview mirrors of the vehicle (i.e., the driver-side mirror mounted at the driver side of the vehicle and/or the passenger-side mirror mounted at the passenger side of the vehicle) are often at an increased risk of collision. That is, drivers of vehicles oftentimes misinterpret an operating width or outermost part of the vehicle by not accounting for the side-mounted exterior rearview mirrors that extend from the respective side of the vehicle. Thus, the side mirror may impact an object (e.g., another vehicle, a wall, a structure, a garage door, etc.) when operating the vehicle in these narrow conditions. In particular, the side mirror may impact a side mirror of another vehicle. That is, the driver may similarly misinterpret an outermost part of the other vehicle by not accounting for a side-mounted exterior rearview mirror of the other vehicle. Modern side mirrors, due to electronics and other features, are quite expensive, and thus damage to the side mirror can cause a significant financial burden for the owner.

In some scenarios, vehicles tow trailers and/or are instrumented with overhanging mirrors or extendable trailer-towing mirrors that further extend from the side of the vehicle. In these scenarios, the trailer and/or overhanging mirrors represent the outermost part of the vehicle rather than the side mirrors of the vehicle. That is, the lateral outermost part of the trailer or the lateral outermost part of the overhanging mirrors will be closer to the detected object than the lateral outermost part of the equipped vehicle. As such, drivers misinterpret the outermost part of the vehicle by an even greater margin due to a lack of accounting for the trailer and/or overhanging mirrors. Thus, the trailer or the overhanging mirrors may impact objects, such as a side mirror of another vehicle. The system may adjust the determined lateral outermost part of the vehicle depending on whether the extendable/retractable mirror is in an extended position or a retracted position. To that end, the vehicular sensing system may determine whether the distance between the lateral outermost part of the trailer or the lateral outermost part of the overhanging mirrors is less than the threshold distance. Optionally, for vehicles with powerfold or breakaway exterior rearview mirrors, the system may adjust the determined lateral outermost part of the vehicle depending on whether the powerfold or breakaway mirror is in an extended or drive or use position or a retracted or folded or non-use position.

Implementations herein are directed towards the sensing system 12 that includes sensors (e.g., lidar, radar, image, and/or ultrasonic sensors) sensing exterior of the vehicle by capturing sensor data. The sensors may be located at one or both side mirrors of the vehicle. Additionally or alternatively, the sensors may be located at front or rear corners of the vehicle, such as each corner of the vehicle (e.g., at the bumpers). The vehicular sensing system may determine, via processing sensor data captured by the sensor(s) to detect presence of objects in the field of sensing of the sensor, a distance between an operating width or lateral outermost part of the vehicle and a detected object. Since there may be one or more lateral outermost parts on each side of the vehicle (e.g., driver-side mirror and the passenger-side mirror), the vehicular sensing system may identify the outermost part of the vehicle at the side of the vehicle that is closest to the detected object and determine the distance between the detected object and the identified outermost part of the vehicle at that side. Thus, the determined distance represents a shortest distance between the equipped vehicle and the detected object. Moreover, the vehicular sensing system may determine an outermost part of the detected object that is closest to the predicted path of travel and determine the distance between the lateral outermost part of the equipped vehicle and the lateral outermost part of the detected object. The location of the sensors may enable the system to determine the distances between the operating width or the lateral outermost part of the vehicle and objects located along a path of travel or projected path of travel of the vehicle while it travels in an operating direction of the vehicle (e.g., forward or rearward). That is, the system may be preconfigured to know a preset distance between the each lateral outermost part of the vehicle and the sensor. To that end, the system determines the distance between the lateral outermost part of the vehicle and the detected object based in part on the preset distance. The object may be another vehicle, or more specifically, a bumper or side mirror of the other vehicle (i.e., a sideward-most part of the other vehicle that is closest to the projected path of travel of the equipped vehicle). Moreover, the vehicular sensing system may determine the distance while the vehicle operates in a forward direction or a rearward direction.

In some implementations, the operating width of the vehicle includes a distance between a driver side mirror (e.g., lateral outermost part of one side of the vehicle) and a passenger side mirror of the vehicle (e.g., lateral outermost part of the other side of the vehicle). That is, the operating width of the vehicle corresponds to a total width of the vehicle defining a driving corridor of the vehicle. The vehicular sensing system determines whether a lateral outermost part of the vehicle (e.g., side mirror of the vehicle) may collide with the object based on a predicted path of travel of the vehicle and the distance between the operating width or the lateral outermost part of the vehicle and the object. The lateral outermost part of the vehicle may represent a location on the vehicle that is closest to the detected object or predicted to be closest to the detected object as the vehicle moves along the predicted path. For example, based on the operating width of the vehicle (e.g., based on a known location of a laterally outboard portion of the vehicle), the vehicular sensing system determines whether the laterally outboard portion (e.g., the side mirror) of the vehicle is likely to impact the object based on determining whether the distance satisfies or is less than a threshold distance. Moreover, in these examples, the determination of whether the side mirror of the vehicle is likely to impact the object may be further based on the predicted path of the vehicle determined by the vehicular sensing system according to a vehicle operating direction (e.g., a forward/reverse direction), a steering angle of the vehicle, speed of the vehicle, map data, processing of image data captured by one or more cameras of the vehicle, processing of radar data captured by one or more radar sensors of the vehicle, etc. That is, the vehicular sensing system may determine that a current distance between the side mirror and the detected object is greater than the threshold distance and predict whether the side mirror will still be less than the threshold distance from the detected object as the vehicle continues to move along the predicted path and passes the detected object.

When the sensing system determines that the vehicle may collide with the object (e.g., distance between the operating width or lateral outermost part of the vehicle and the object satisfies the threshold) the system generates a collision warning for a driver of the vehicle or may control steering and/or braking of the vehicle to avoid collision. Notably, the sensing system generates the collision warning before the vehicle collides with the object such that the driver or driving assist system of the vehicle may instruct the vehicle to maneuver to avoid the predicted collision before the collision occurs. The threshold distance may be a predetermined threshold, for example, one (1) foot, or 6 inches (or any suitable distance), such that the vehicular sensing system generates the collision warning based on determining that distance between the operating width of the vehicle and the object is less than the (1) foot (or other distance) threshold. The predetermined threshold may be a driver-configurable parameter. The collision warning may be a visual warning (e.g., at a display disposed within the vehicle, on a head-up display (HUD), etc.), audible (e.g., a chime or other sound played via speakers of the vehicle), or haptic (e.g., a vibration of a seat or steering wheel of the vehicle). Thus, the driver of the vehicle may maneuver the vehicle to avoid the collision responsive to receiving the collision warning.

In some scenarios, however, the operating width of the vehicle is greater (e.g., larger) than the distance the between the outermost portion of the driver side mirror and the outermost portion of the passenger side mirror of the vehicle. For example, the vehicle may be towing a trailer where the width of the trailer is greater than the distance the between the outermost portion of the driver side mirror and the outermost portion of the passenger side mirror of the vehicle (e.g., the width of the vehicle). Additionally or alternatively, the vehicle may be instrumented with overhanging side mirrors (e.g., extendable trailer-towing mirrors that extend further outboard from the side of the vehicle to enhance the driver's rearward view along the side of and rearward of the trailer) disposed at the side of the vehicle such that the overhanging mirrors extend beyond where non-extended side mirrors of the vehicle would be (e.g., extend beyond the initial operating width or initial outermost part of the vehicle). In these scenarios, the vehicle (e.g., the overhanging mirrors or the trailer) may still collide with the object even when the distance between the initial operating width or initial outermost part of the vehicle and the object exceeds (e.g., fails to satisfy) the threshold distance because the trailer and/or the overhanging mirrors extend beyond the initial or preset operating width or outermost part of the vehicle. To that end, the vehicle sensing system needs to account for the overhanging side mirrors or trailer by adjusting the outermost part of the vehicle and/or adjusting the threshold distance.

Accordingly, the vehicular sensing system may adjust the determined or set operating width or outermost part of the vehicle to accommodate the width of the trailer being towed by the vehicle and/or a distance between the outermost portion of a driver side overhanging mirror and the outermost portion of a passenger side overhanging mirror. Additionally or alternatively, the vehicular sensing system may adjust the threshold distance to accommodate the width of the trailer being towed by the vehicle and/or the outermost portion of the overhanging mirrors. That is, the vehicular sensing system may adjust the outermost part of the vehicle to now represent the outermost part of the trailer or overhanging mirrors. Optionally, the driver of the vehicle may provide input to the vehicular sensing system defining the adjusted operating width of the vehicle. Thus, the vehicular sensing system may determine an adjusted distance between the adjusted operating width of the vehicle and the object and determine whether the distance satisfies the threshold. Here, determining that the adjusted distance satisfies the threshold indicates that the trailer or one the overhanging mirrors is likely to collide with the object. When the adjusted distance satisfies the threshold, the vehicular sensing system generates the collision warning for the driver of the vehicle.

Each side of the equipped vehicle has a plurality of lateral outermost parts each associated with a respective height. For example, the detected object may be a curb such that even though a side mirror of the equipped vehicle may be close to the curb (e.g., less than the threshold distance), the side mirror may pass over the curb without colliding with the curb. To that end, the vehicular sensing system determines a height of the detected object and then identifies a lateral outermost part from the plurality of lateral outermost parts of the vehicle based on the determined height of the detected object. In particular, the respective height of the identified lateral outermost part of the vehicle may be at or below the determined height of the detected object such that the identified lateral outermost part presents a collision risk with the detected object. Thereafter, the vehicular sensing system determines the distance between the identified lateral outermost part of the vehicle and the detected object.

For example, when the detected object is a curb or other object below a ground clearance height of the vehicle, the lateral outermost part of the vehicle may be the outer sidewall of one of the tires of the vehicle (and may adjust based on steering angle of the tire). Alternatively, if the detected object has a height greater than the ground clearance of the vehicle but less than the height of the exterior rearview mirror, the lateral outmost part of the vehicle may be a side trim at the wheel well or a outermost part of a running board or a side trim strip along the side of the vehicle or a door handle of the vehicle. If the detected object has a height at or greater than the height of the exterior rearview mirror, the lateral outermost part of the vehicle may be the outermost part of the mirror head, which may change if the mirror head is extendable or retractable relative to the side of the vehicle.

In some examples, responsive to generating the collision warning, the vehicular sensing system, via the driver assist system, controls the vehicle to maneuver to avoid the predicted collision. For example, the maneuver may include correcting a driving lane of the vehicle by steering the vehicle away from the object. In other examples, the maneuver includes slowing or stopping the vehicle by controlling braking or acceleration of the vehicle.

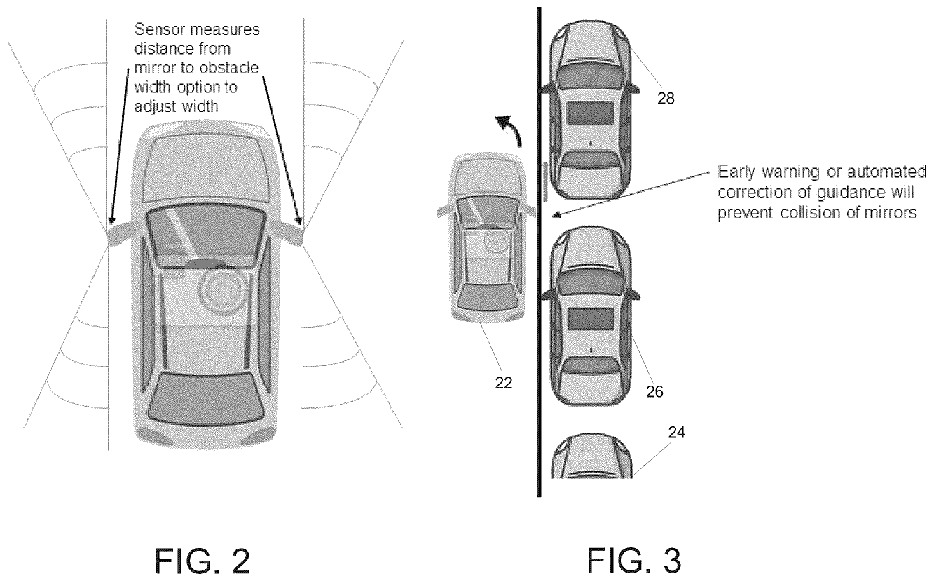

FIG. 2 depicts an operating vehicle equipped with the vehicular sensing system and includes a first sensor disposed at a passenger side mirror of the vehicle and a second sensor disposed at a driver side mirror of the vehicle. Each sensor has a field of sensing in both a forward and rearward direction of the vehicle. FIG. 3 depicts an operating vehicle 22 driving alongside other vehicles 24, 26, 28 proximal to the passenger side of the operating vehicle 22. The vertical line located between the operating vehicle 22 and the other vehicles 24, 26, 28 represents a threshold distance between the operating width or outermost part of the vehicle 22 and the object (e.g., the driver side mirrors of the other vehicles 24, 26, 28). Accordingly, as shown in FIG. 3, the vehicular sensing system determines that the distance between the operating width of the vehicle 22 and one of the objects (e.g., distance between the passenger side mirror of the operating vehicle 22 and the driver side mirror of the other vehicle 28) will be below the threshold distance as the vehicle 22 moves along the predicted path. Responsive to determining the distance is less than the threshold distance (e.g., satisfies the threshold), the system generates the collision warning for the vehicle 22. Advantageously, the driver of the vehicle 22 may correct operation of the vehicle 22 to avoid the collision with the other vehicle 28 and/or the driving assist system at least in part controls the vehicle 22 to maneuver to avoid the collision without input from the driver.

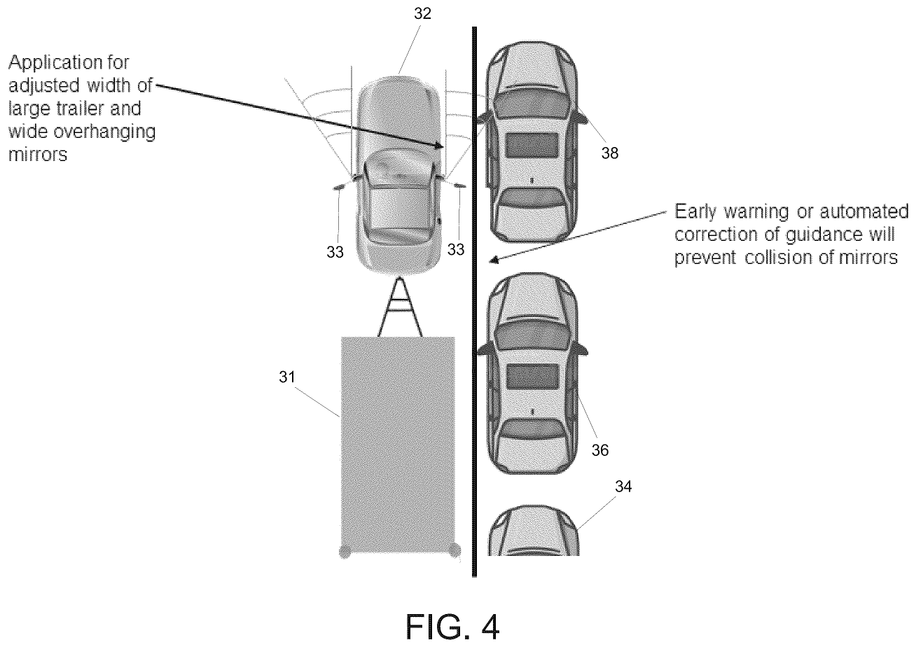

FIG. 4 depicts an operating vehicle 32 towing a trailer 31 and instrumented with overhanging mirrors 33 disposed on the side mirrors of the vehicle. The operating vehicle 32 is driving alongside other vehicles 34, 36, 38 proximal to the passenger side of the operating vehicle 32. The operating vehicle 32 is equipped with the vehicular sensing system and includes a first sensor disposed at a non-extended passenger side mirror of the vehicle 32 and a second sensor disposed at a non-extendable driver side mirror of the vehicle 32. The vertical line located between the operating vehicle 32 and the other vehicles 34, 36, 38 represents the threshold distance between the adjusted operating width of the vehicle 32 and the object (e.g., the distance between the passenger side overhanging mirror 33 or the trailer 31 and the driver side mirrors of the other vehicles 34, 36, 38). Here, the vehicular sensing system determines an adjusted distance between the adjusted operating width of the vehicle 32 and the object. The adjusted distance may be a distance between the passenger side overhanging mirror 33 of the operating vehicle 32 (which is further outboard than the non-extended mirror where the sensor may be located) and the driver side mirror of the other vehicles 34, 36, 38. Additionally or alternatively, the adjusted distance may be a distance between the trailer 31 being towed by the vehicle 32 and the driver side mirror of the other vehicles 34, 36, 38. As shown in FIG. 4, the vehicular sensing system determines that the adjusted distance is less than the threshold (e.g., satisfies the threshold) and, responsive to the determination, generates the collision warning. Advantageously, the driver of the vehicle 32 may correct operation of the vehicle 32 to avoid the collision and/or the driver assist system instructs the vehicle 32 to maneuver to avoid the collision without input from the driver.

In some implementations, a position of the driver-side mirror and/or passenger-side mirror is adjustable between an extended position and a retracted position. Here, the lateral outermost part of the equipped vehicle is determined based on the position of the side mirrors with the side mirrors in the extended position. As such, responsive to determining that the driver-side mirror and/or passenger-side mirror is at the extended position and that the distance between the extended driver-side mirror and/or extended passenger side mirror and the detected object is less than the threshold distance, the vehicular sensing system may retract the side mirror toward the retracted position so as to increase the distance between the detected object and the side mirror. The vehicular sensing system may retract the side mirror in addition to, or in lieu of, generating the alert or maneuvering the vehicle.

The sensor may be disposed at the exterior rearview mirror so as to sense forward or rearward of the mirror and vehicle generally along the path of travel of the outermost portion of the vehicle. The system may determine or may be set up with a known location of the outermost portion of the vehicle relative to the sensor location. That is, the system may be set to know a distance between the sensor location and the outermost portion of the vehicle. The system may process sensor data as the vehicle travels along the projected path of travel to determine where the outermost portion of the vehicle (e.g., the outermost part of the exterior rearview mirror) is at while the vehicle moves along the path of travel. Thus, the system may process sensor data captured by the sensor and, based on a projected path of travel of the vehicle (which may be determined in part responsive to speed and steering inputs and lane marker determination), the system may determine if a detected object will encroach on the path of travel of the outermost portion of the vehicle. If the sensor is at a non-extending portion of an extendable trailer-towing mirror, then the system adjusts processing of the sensor data to accommodate the extended trailer-towing mirror and/or trailer width when the mirror is extended and/or when the vehicle is towing a trailer.

The system may be suitable for driver-operated vehicles and/or for autonomous vehicles, whereby the vehicle is controlled or maneuvered along the road by the system. For autonomous vehicles suitable for deployment with the system, an occupant of the vehicle may, under particular circumstances, be desired or required to take over operation/control of the vehicle and drive the vehicle so as to avoid potential hazard for as long as the autonomous system relinquishes such control or driving. Such an occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

The sensor may comprise any suitable sensor, such as a radar sensor, a lidar sensor, an ultrasonic sensor or the like. The system thus may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controls at least one function or feature of the vehicle (such as to provide autonomous driving control of the vehicle) responsive to processing of the data captured by the radar sensors.

Optionally, it is envisioned that the sensor may comprise a forward and/or rearward viewing camera disposed at the exterior mirror or other sideward portion of the vehicle. The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 9,896,039; 9,871,971; 9,596,387; 9,487,159; 8,256,821; 7,480,149; 6,824,281 and/or 6,690,268, and/or U.S. Publication Nos. US-2020-0039447; US-2015-0327398; US-2015-0015713; US-2014-0160284; US-2014-0226012 and/or US-2009-0295181, which are all hereby incorporated herein by reference in their entireties.

The system may utilize aspects of the parking assist systems described in U.S. Pat. No. 8,874,317 and/or U.S. Publication Nos. US-2017-0329346; US-2017-0317748; US-2017-0253237; US-2017-0050672; US-2017-0017848; US-2017-0015312 and/or US-2015-0344028, which are hereby incorporated herein by reference in their entireties.

The system may utilize aspects of the trailering assist systems or trailer angle detection systems or trailer hitch assist systems described in U.S. Pat. Nos. 10,755,110; 10,733,757; 10,706,291; 10,638,025; 10,586,119; 10,552,976; 10,532,698; 10,160,382; 10,086,870; 9,558,409; 9,446,713; 9,085,261 and/or 6,690,268, and/or U.S. Publication Nos. US-2022-0028111; US-2022-0027644; US-2022-0024391; US-2021-0170947; US-2021-0170820; US-2021-0078634; US-2020-0406967; US-2020-0361397; US-2020-0356788; US-2020-0334475; US-2020-0017143; US-2019-0347825; US-2019-0118860; US-2019-0064831; US-2018-0276838; US-2018-0215382; US-2017-0254873; US-2017-0217372 and/or US-2015-0002670, and/or International Publication No. WO 2021/0127693, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a sensor disposed at a vehicle equipped with the vehicular sensing system and sensing exterior of the vehicle;
an electronic control unit (ECU) comprising electronic circuitry and associated software;
wherein the sensor is operable to capture sensor data;
wherein sensor data captured by the sensor is transferred to the ECU
wherein the electronic circuitry of the ECU comprises a data processor for processing sensor data captured by the sensor and transferred to the ECU;
wherein the vehicular sensing system, via processing at the ECU of the sensor data captured by the sensor, detects an object present exterior of the vehicle;
wherein the equipped vehicle has a lateral outermost part at a side of the equipped vehicle;
wherein the vehicular sensing system, responsive to detecting the object present exterior of the vehicle, and based on a predicted path of travel of the equipped vehicle approaching the detected object, estimates a distance between the detected object and the lateral outermost part of the equipped vehicle at the side of the equipped vehicle that, as the equipped vehicle moves along the predicted path of travel and approaches the detected object, will be closest to the detected object; and
wherein the vehicular sensing system determines that the distance between the lateral outermost part of the equipped vehicle and the detected object is less than a threshold distance.

2. The vehicular sensing system of claim 1, wherein the lateral outermost part of the equipped vehicle comprises a lateral outermost part of a driver-side mirror of the equipped vehicle or a lateral outermost part of a passenger-side mirror of the equipped vehicle.

3. The vehicular sensing system of claim 2, wherein the detected object comprises another vehicle, and wherein determining the distance between the lateral outermost part of the equipped vehicle and the detected object comprises determining a distance between the lateral outermost part of the driver-side mirror of the equipped vehicle and an exterior side mirror of the other vehicle.

4. The vehicular sensing system of claim 2, wherein the detected object comprises another vehicle, and wherein determining the distance between the lateral outermost part of the equipped vehicle and the detected object comprises determining a distance between the lateral outermost part of the passenger-side mirror of the equipped vehicle and an exterior side mirror of the other vehicle.

5. The vehicular sensing system of claim 2, wherein a position of the driver-side mirror is adjustable between an extended position and a retracted position, and wherein the lateral outermost part of the equipped vehicle is determined based on the position of the driver-side mirror.

6. The vehicular sensing system of claim 5, wherein the vehicular sensing system, responsive to determining that the driver-side mirror is at the extended position and that the distance between the driver-side mirror at the extended position and the detected object is less than the threshold distance, retracts the driver-side mirror toward the retracted position.

7. The vehicular sensing system of claim 2, wherein a position of the passenger-side mirror is adjustable between an extended position and a retracted position, and wherein the lateral outermost part of the equipped vehicle is determined based on the position of the passenger-side mirror.

8. The vehicular sensing system of claim 7, wherein the vehicular sensing system, responsive to determining that the passenger-side mirror is at the extended position and that the distance between the passenger-side mirror at the extended position and the detected object is less than the threshold distance, retracts the passenger-side mirror toward the retracted position.

9. The vehicular sensing system of claim 1, wherein, with the equipped vehicle towing a trailer, the vehicular sensing system determines that a lateral outermost part of the trailer being towed by the equipped vehicle will be closer to the detected object than the lateral outermost part of the equipped vehicle as the equipped vehicle tows the trailer along the predicted path of travel and as the lateral outermost part of the trailer approaches the detected object, and wherein the vehicular sensing system determines that the distance between the lateral outermost part of the trailer being towed by the equipped vehicle and the detected object is less than the threshold distance.

10. The vehicular sensing system of claim 9, wherein width of the equipped vehicle is less than width of the trailer being towed by the equipped vehicle.

11. The vehicular sensing system of claim 1, wherein the equipped vehicle is equipped with an extendable trailer-towing mirror disposed at the side of the equipped vehicle, and wherein a position of the extendable trailer-towing mirror is adjustable between an extended position and a retracted position, wherein the lateral outermost part of the equipped vehicle comprises a lateral outermost part of the extendable trailer-towing mirror.

12. The vehicular sensing system of claim 11, wherein the lateral outermost part of the equipped vehicle is determined based on the position of the extendable trailer-towing mirror.

13. The vehicular sensing system of claim 1, wherein the vehicular sensing system, responsive to detecting the object present exterior of the vehicle, determines a lateral outermost part of the detected object that is closest to the predicted path of travel, and wherein the vehicular sensing system determines the distance between the lateral outermost part of the equipped vehicle and the lateral outermost part of the detected object.

14. The vehicular sensing system of claim 13, wherein the detected object comprises another vehicle, and wherein the lateral outermost part of the detected object comprises an exterior rearview mirror of the detected other vehicle.

15. The vehicular sensing system of claim 1, wherein the vehicular sensing system, responsive to determining that the distance between the lateral outermost part of the equipped vehicle and the detected object is less than the threshold distance, generates an alert to a driver of the equipped vehicle.

16. The vehicular sensing system of claim 15, wherein the alert comprises at least one selected from the group consisting of (i) a visual alert, (ii) an audible alert and (iii) a haptic alert.

17. The vehicular sensing system of claim 1, wherein the vehicular sensing system, responsive to determining that the distance between the lateral outermost part of the equipped vehicle and the detected object is less than the threshold distance, maneuvers the equipped vehicle to mitigate a collision with the detected object by at least one selected from the group consisting of (i) controlling braking of the equipped vehicle and (ii) controlling steering of the equipped vehicle.

18. The vehicular sensing system of claim 1, wherein the sensor is disposed at an exterior rearview mirror of the equipped vehicle.

19. The vehicular sensing system of claim 1, wherein the sensor comprises at least one selected from the group consisting of (i) a lidar sensor, (ii) a radar sensor and (iii) an ultrasonic sensor.

20. The vehicular sensing system of claim 1, wherein the sensor comprises a camera.

21. The vehicular sensing system of claim 1, wherein the sensor senses at least forward of the vehicle, and wherein the predicted path of travel of the equipped vehicle comprises a predicted forward path of travel as the equipped vehicle maneuvers forward.

22. The vehicular sensing system of claim 1, wherein the sensor senses at least rearward of the vehicle, and wherein the predicted path of travel of the equipped vehicle comprises a predicted rearward path of travel as the equipped vehicle maneuvers rearward.

23. The vehicular sensing system of claim 1, wherein the vehicular sensing system, responsive to detecting the object, (i) determines height of the detected object and (ii) determines, from a plurality of lateral outermost parts of the equipped vehicle each associated with a respective height, the lateral outermost part of the vehicle at the side of the equipped vehicle that will be closest to the detected object based in part on the determined height of the detected object.

24. The vehicular sensing system of claim 23, wherein the height of the determined lateral outermost part of the vehicle is at or below the determined height of the detected object.

25. A vehicular sensing system, the vehicular sensing system comprising:
a sensor disposed at a vehicle equipped with the vehicular sensing system and sensing exterior of the vehicle;
an electronic control unit (ECU) comprising electronic circuitry and associated software;
wherein the sensor is operable to capture sensor data;
wherein sensor data captured by the sensor is transferred to the ECU wherein the electronic circuitry of the ECU comprises a data processor for processing sensor data captured by the sensor and transferred to the ECU;
wherein the vehicular sensing system, via processing at the ECU of the sensor data captured by the sensor, detects an object present exterior of the vehicle;
wherein the equipped vehicle has a lateral outermost part at a side of the equipped vehicle, wherein the lateral outermost part of the equipped vehicle comprises a lateral outermost part of a passenger-side mirror of the equipped vehicle;
wherein the vehicular sensing system, responsive to detecting the object present exterior of the vehicle, and based on a predicted path of travel of the equipped vehicle approaching the detected object, estimates a distance between the detected object and the lateral outermost part of the equipped vehicle at the side of the equipped vehicle that, as the equipped vehicle moves along the predicted path of travel and approaches the detected object, will be closest to the detected object;
wherein the vehicular sensing system determines that the distance between the lateral outermost part of the equipped vehicle and the detected object is less than a threshold distance; and
wherein the vehicular sensing system, responsive to determining that the distance between the lateral outermost part of the equipped vehicle and the detected object is less than the threshold distance, generates an alert to a driver of the equipped vehicle.

26. The vehicular sensing system of claim 25, wherein the detected object comprises another vehicle, and wherein determining the distance between the lateral outermost part of the equipped vehicle and the detected object comprises determining a distance between the lateral outermost part of the passenger-side mirror of the equipped vehicle and an exterior side mirror of the other vehicle.

27. The vehicular sensing system of claim 25, wherein a position of the passenger-side mirror is adjustable between an extended position and a retracted position, and wherein the lateral outermost part of the equipped vehicle is determined based on the position of the passenger-side mirror.

28. The vehicular sensing system of claim 27, wherein the vehicular sensing system, responsive to determining that the passenger-side mirror is at the extended position and that the distance between the passenger-side mirror at the extended position and the detected object is less than the threshold distance, retracts the passenger-side mirror toward the retracted position.

29. The vehicular sensing system of claim 25, wherein the alert comprises at least one selected from the group consisting of (i) a visual alert, (ii) an audible alert and (iii) a haptic alert.

30. A vehicular sensing system, the vehicular sensing system comprising:
a sensor disposed at a vehicle equipped with the vehicular sensing system and sensing exterior of the vehicle;
an electronic control unit (ECU) comprising electronic circuitry and associated software;
wherein the sensor is operable to capture sensor data;
wherein sensor data captured by the sensor is transferred to the ECU
wherein the electronic circuitry of the ECU comprises a data processor for processing sensor data captured by the sensor and transferred to the ECU;
wherein the vehicular sensing system, via processing at the ECU of the sensor data captured by the sensor, detects an object present exterior of the vehicle;
wherein, with the equipped vehicle towing a trailer, the trailer has a lateral outermost part at a side of the trailer;
wherein the vehicular sensing system, responsive to detecting the object present exterior of the vehicle, and based on a predicted path of travel of the equipped vehicle and the trailer approaching the detected object, estimates a distance between the detected object and the lateral outermost part of the trailer at the side of the trailer that, as the equipped vehicle and the trailer move along the predicted path of travel and approach the detected object, will be closest to the detected object; and
wherein the vehicular sensing system determines that the distance between the lateral outermost part of the trailer and the detected object is less than a threshold distance.

31. The vehicular sensing system of claim 30, wherein width of the equipped vehicle is less than width of the trailer being towed by the equipped vehicle.

32. The vehicular sensing system of claim 30, wherein the vehicular sensing system, responsive to detecting the object present exterior of the vehicle, determines a lateral outermost part of the detected object that is closest to the predicted path of travel, and wherein the vehicular sensing system determines the distance between the lateral outermost part of the trailer and the lateral outermost part of the detected object.

33. The vehicular sensing system of claim 32, wherein the detected object comprises another vehicle, and wherein the lateral outermost part of the detected object comprises an exterior rearview mirror of the detected other vehicle.

34. The vehicular sensing system of claim 30, wherein the vehicular sensing system, responsive to determining that the distance between the lateral outermost part of the trailer and the detected object is less than the threshold distance, generates an alert to a driver of the equipped vehicle.

35. The vehicular sensing system of claim 30, wherein the vehicular sensing system, responsive to determining that the distance between the lateral outermost part of the trailer and the detected object is less than the threshold distance, maneuvers the equipped vehicle to mitigate a collision with the detected object by at least one selected from the group consisting of (i) controlling braking of the equipped vehicle and (ii) controlling steering of the equipped vehicle.
